(19) United States
(12) Patent Application Publication
(10) Pub. No.: US 2003/0233360 A1
(43) Pub. Date: Dec. 18, 2003

(54) Multiple-item searching method

(76) Inventor: Chai-Hup Tan, Arcadia, CA (US)

Correspondence Address: Raymond Y. Chan, Suite 128, 108 N. Ynez Avenue, Monterey Park, CA, 91754, US

(21) Appl. No.: 10/172,440

(22) Filed: Jun. 17, 2002

(51) Int. Cl. G06F 17/30

(52) U.S. Cl. 707/7

(57) ABSTRACT

A multiple-item searching method includes the steps of providing an information center linked to a plurality of product databases of supplier through an electronic communication system wherein each of the product database contains price information and contact information for a set of products of the respective supplier; receiving a search request, by a user, including two or more searchable items and a sorting criteria; searching the product databases of the suppliers for said searchable items to generate at least a search result for each of the searchable items; combining the search results of the searchable items together to form an array of product results; sorting out the array of product results according to the sorting criteria to form a set of sorted product results; and providing the sorted product results for the user.

### BACKGROUND OF THE PRESENT INVENTION

1. Field of Invention

The present invention relates to a multiple-item searching method, which allows one to search two or more items through an electronic communication system at the same time in order to provide a prompt and effective inclusive result of the items at a lower cost.

2. Description of Related Arts

In recent years, the global computer network, or the Internet plays a very important role in the worldwide economy. The Internet affects not only the development of the modern computer and communicating technologies, but also the development of the business of buying and selling other than the traditional retailing channels. Especially, the Internet affects the traditional marketplaces that bring buyers and suppliers together.

Nowadays, almost all of the traditional worldwide retailing companies offer to sell their products and services directly through their own web sites or indirectly through paid advertisements within the Internet because the consumers may do their shopping and purchasing at home through the Internet. These consumers often like to search the desired item and find the lowest price among those shopping web sites. One of the convenient methods presently available is to use a search engine for searching the desired item among those thousands of shopping web sites.

However, the conventional search engine has several drawbacks. When the consumer wants to search for two or more items, he or she may merely search these items one by one and get the search results with respect to each item. It is worth mentioning, that in each search result, there can be a long list of companies for the consumer to select with respect to a single item. It is a waste of time for the consumer to search each item individually and compare those search results in order to determine the best overall price for each of the desired items. Moreover, the consumer may have to pay extra shipping and handling charges when he or she purchases the items from various web sellers respectively. In other words, the consumer will spend additional time to find out whether the company has any promotion, the shipping and handling fees, and the locations of the companies so as to minimize the total cost of the purchase and the time spent searching.

For example, when the consumer wants to purchase three books, under a conventional search, the consumer must search the three books individually so as to give three different search results to the books respectively. However, these search results may not be related with each other, such as company A having a promotion on the book A, company B having free handling charge while purchasing the second book, or company C providing no sales tax while purchasing. Therefore, the consumer must use his or her own experience to get the best quotation of the combination of the books among those search results. In other words, the conventional search engine can only provide an one-directional search for a single item and give the straightforward result of the single item.

### SUMMARY OF THE PRESENT INVENTION

It is a main objective to provide a solution to the above-mentioned problems and concerns, the present invention provides a multiple-item searching method which allows one to search two or more selected items through a search engine at the same time. Instead of providing several search results from the conventional search engine, the present invention gives only one single product result to summarize the contacts and billing information of the selected items according to the user's preference.

In other words, the conventional search method requires multiple-search inputs to generate multiple search outputs respectively. The present invention requires one search input to generate one search output including multiple searchable items. Therefore, the user is able to easily target the selected items in a more economical and effective way.

It is another objective of the present invention to provide a multiple-item searching method, wherein the search engine is adapted to compare and sort out all the search results of the selected items in order to provide the product result. According to the user's preference, such as price or location, the product result lists out the best combinations of the selected items, so as to save the user's time and reduce the time for the consumer to spend to make a purchase from a company or companies for the selected items.

It is another objective of the present invention to provide a method for multiple-item searching method, wherein a product result with respect to the price preference not only provides the price of each selected item but also provides the total amount of the selected items including deductions for any promotions, the shipping and handling charges and the sales taxes. Therefore, the user does not have to guess the lowest cost for all the selected items by totaling the prices of each selected item while other charges, such as the shipping and handling charges and sales tax, of the selected items are unknown.

When the location preference is chosen, the product result provides all the convenient locations of the companies that carry the selected items. Moreover, the product result is capable of grouping the searchable items together in order to calculate the total cost of the searchable items including the handling fee. Therefore, the user is able to purchase all the selected items at once in order to save the cost of delivery.

Accordingly, in order to accomplish the above objects, the present invention provides a multiple-item searching method, comprising the steps of:

(a) providing an information center linked to a plurality of product databases through an electronic communication system, each of the product databases having price information and contact information for a set of products and suppliers thereof;

(b) receiving a search request at the information center, by a user, including two or more searchable items and at least a sorting criteria;

(c) searching the product databases of the suppliers for the searchable items to generate at least a search result for each of the searchable items;

(d) combining the search results of each of the searchable items together to form an array of product results;

(e) sorting out the array of product results according to the sorting criteria to form an array of sorted product results; and

(f) providing the sorted product results for the user.

### BRIEF DESCRIPTION OF THE DRAWINGS

FIG. 1 is a flow chart of a method for multiple-item searching according to a preferred embodiment of the present invention.

FIG. 2 is a flow chart of an input collection of the multiple-item searching method according to the above preferred embodiment of the present invention.

FIG. 3 is a flow chart of a user profile of the input collection of the multiple-item searching method according to the above preferred embodiment of the present invention.

FIG. 4 illustrates a sub-menu of the user profile of the input collection of the multiple-item searching method according to the above preferred embodiment of the present invention.

FIG. 5 is a flow chart of a price collection of the multiple-item searching method according to the above preferred embodiment of the present invention.

FIG. 6 is a flow chart of a core calculation of the price collection of the multiple-item searching method according to the above preferred embodiment of the present invention.

FIG. 7 illustrates a first sub-menu of the core calculation of the multiple-item searching method according to the above preferred embodiment of the present invention.

FIG. 8 illustrates a second sub-menu of the core calculation of the multiple-item searching method according to the above preferred embodiment of the present invention.

FIG. 9 illustrates a third sub-menu of the core calculation of the multiple-item searching method according to the above preferred embodiment of the present invention.

FIG. 10 illustrates a fourth sub-menu of the core calculation of the multiple-item searching method according to the above preferred embodiment of the present invention.

### DETAILED DESCRIPTION OF THE PREFERRED EMBODIMENT

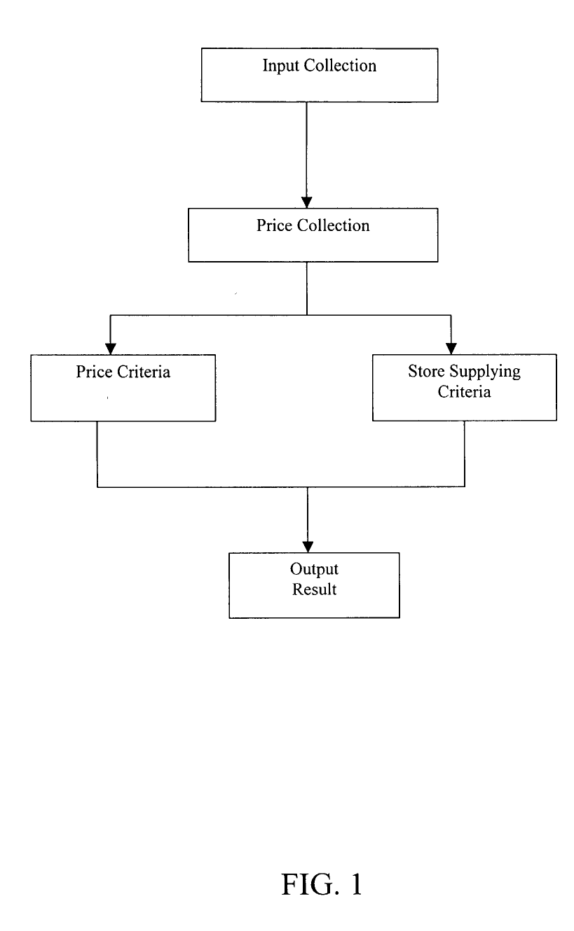

Referring to FIGS. 1 through 10, a multiple-item searching method according to a preferred embodiment of the present invention is illustrated. As shown in FIG. 1, the multiple-item searching method of the present invention generally comprises three main sections, which are input collection, price collection, and output result.

The purpose of the input collection of the multiple-item searching method is to receive any desirable item selected from a consumer. The objective of the price collection is mainly to search the desirable items at the same time and to determine the lowest prices of the desirable items so as to provide an inclusive result for the consumer in the section of the output result.

Accordingly, the multiple-item searching method according to the preferred embodiment of the present invention comprises the following steps.

1. Provide an information center linked to a plurality of product databases through an electronic communication system. Each of the product databases has price information and contact information for a set of products and respective suppliers thereof.

2. Receive a search request at the information center, by a user, including two or more searchable items and at least a sorting criteria.

3. Search the product databases of the suppliers for the searchable items to generate at least a search result for each of the searchable items.

4. Combine the search results of each of the searchable items together to form an array of product results.

5. Sort out the array of product results according to the sorting criteria to form an array of sorted product results.

6. Provide the sorted product results to the user.

In step (1), the information center, which can be a web based control center, should be equipped with a search engine adapted to establish a communication link to the product databases of the suppliers, wherein the suppliers are preferably contracted with the information center, such that the information center can receive a predetermined fee from the suppliers so as to provide a mutual benefit between the information center and the suppliers for any purchases. As it is mentioned that each supplier, such as big sales department, should have its own product database that allows one to directly link to the product database for shopping through the electronic communication system. The product database of each supplier should comprise a plurality of products carried by the supplier wherein the price information and contact information should be included in the product database.

Accordingly, the price information generally provides a retail price of the product, a shipping and handling charge, sales tax, and any promotion. The contact information provides a specification of the product, types of payment, and shipping time.

The product databases of the suppliers are linked together by the information center so that the user is able to search the desirable item within the product databases of the suppliers at once to provide a best quotation of each of the desirable items.

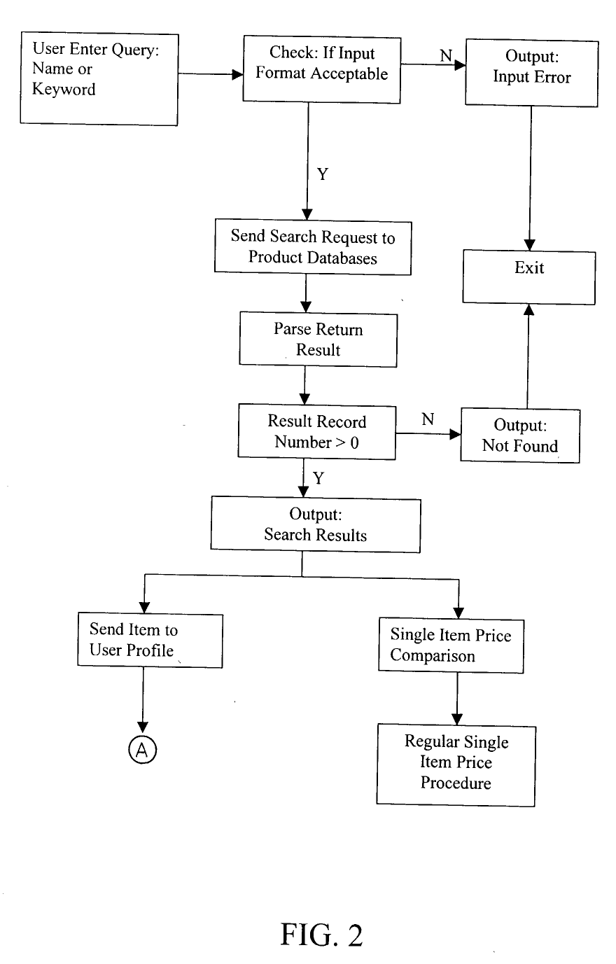

In step (2), the user is allowed to input two or more searchable items to the information center. Conventionally, the user can only input one searchable item to a conventional search engine. However, the information center allows the user to input two or more searchable items at the same time whether the two or more searchable items are co-related or not, such as digital camera and flash memory, or watches and toys, as shown in FIG. 2.

Each of the searchable items can be a generic name, a keyword of the product or a specific model of the product in order to perform a search for the searchable items in step (3). For example, if the user inputs a DVD machine as the searchable item, the information center will search all the databases that the suppliers carry the DVD machine. If the user inputs a particular name of the searchable item, such as Book “A,” the information center will only search for the databases that the suppliers carry the book named “A.”

Preferably, each searchable item should be input with its particular name such that the information center is adapted to precisely find out the searchable item based upon the databases. However, if the user inputs the Book “A” as the particular name of the searchable item as mentioned in above example, the information center may still find out the Book “A” consisting of a hard cover version, a soft cover version, and a special edition. Therefore, as long as the user does not mention the particular version of the Book “A,” all versions of the Book “A” are included in the search result in the step (3).

It is worth mentioning that the information center can also function as a conventional search engine to help the user to find out the particular name or item by narrowing the scope of search. In other words, the user is able to input a single searchable item of “book” to the information center and particularly reach the destination of Book “A,” as shown in FIG. 2.

Moreover, after searching through the databases, the information normally generates at least one search result corresponding to each of the searchable items. If there is no match for the searchable item, no search result is provided and a message of “not found” will be shown, as illustrated in FIG. 2. Generally speaking, each of the searchable items should generate an array of search results based upon the databases. In other words, various suppliers carry the corresponding product.

Accordingly, the sorting criteria is embodied as a price criteria or a store supplying criteria, wherein when the user selects the price criteria, the information center will search all possible search results from the databases in order to provide the lowest cost of each of the searchable items such that the search results are sorted by calculating total prices of the search results respectively in an ascending order. When the user selects the store supplying criteria, the information center will search all possible search results from the databases based upon which supplier carries the most searchable items. In other words, the search results are sorted by determining which supplier carries most of the searchable items in a descending order.

After the step (3), the present invention further comprises the steps of:

(3.1) collecting at least one of the search results of each of the searchable items into a user profile; and

(3.2) updating the searchable items in the user profile in order to combine the corresponding search results together.

In the step (3.1), the user profile is a database created by the information center for the respective user, wherein the user profile is mainly used as a collecting center to collect the searchable items for further calculation purposes.

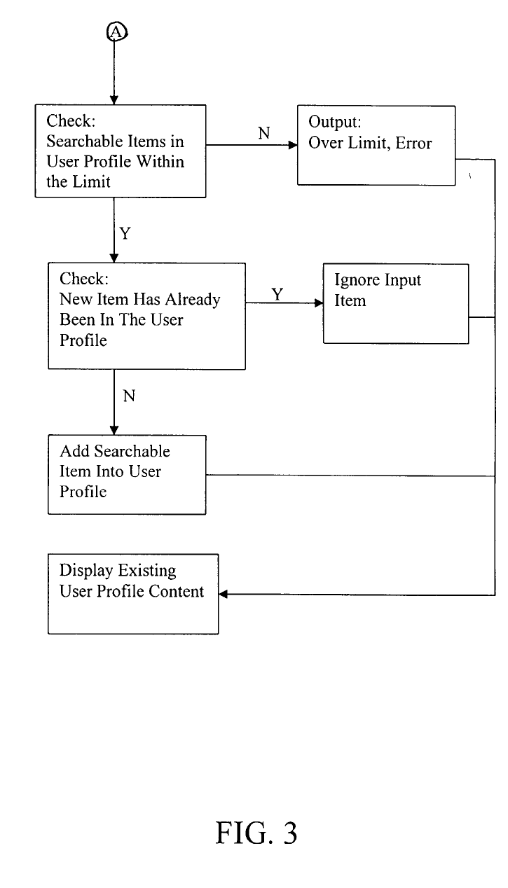

In the step (3.2), the user is able to add the searchable items into the user profile or delete the searchable items from the user profile, as shown in FIG. 3, wherein the searchable items saved in the user profile are arranged to be combined in the step (4).

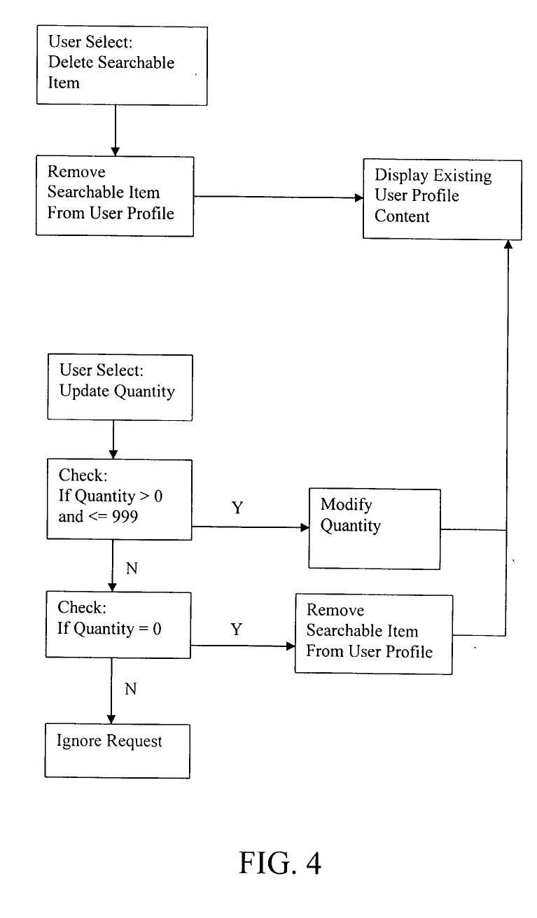

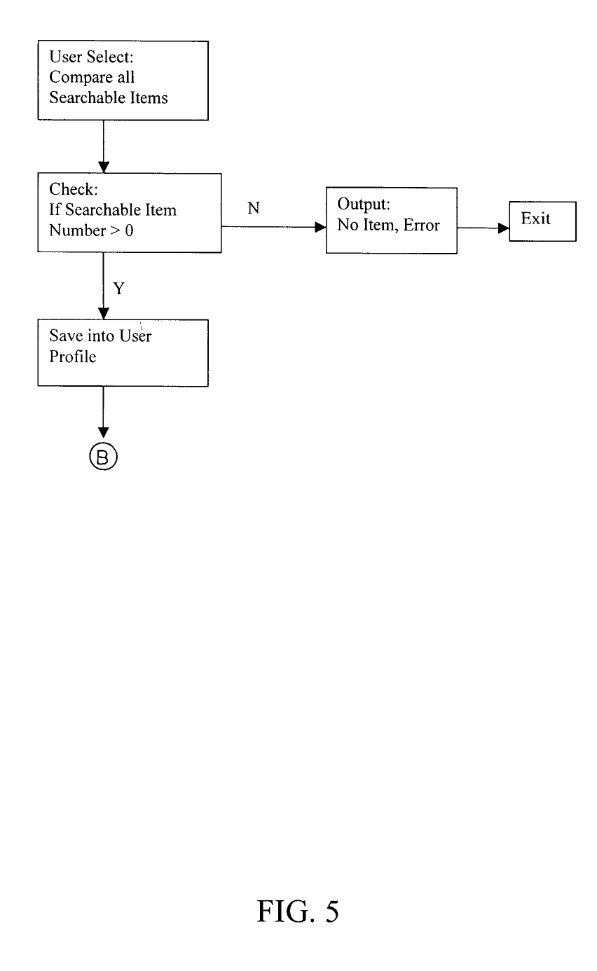

Furthermore, the searchable items in the user profile are updated after each modification by the user, as shown in FIGS. 3 and 4. For example, the quantity of each searchable item is checked in the user profile. Therefore, the user is able to select more than one searchable item and desired quantity of each searchable item in the user profile. It is worth mentioning that the search results of the searchable items are also saved in the user profile in such a manner that the price information and the contact information of the respective searchable item is loaded into the user profile as well, as shown in FIG. 5.

Due to the fact that some common searchable items with large demand in the market may be carried by more than one supplier, the search results of each searchable item are sorted out orderly by determining which supplier would provide the searchable item based on economics and efficiency, including which supplier is located closer to the user and which supplier has more stock for shipping out the searchable item earlier, so as to provide the lowest cost for the user and delivery the searchable item to the user in the shortest time.

According to the multiple-item searching method of the present invention, the step (4) is carried out by the information center and further comprises the steps of:

(4.1) dividing the search results of each searchable item into a predetermined number of constructive search results and a predetermined number of destructive search results; and

(4.2) saving the constructive search results in the information center and discarding the destructive search results.

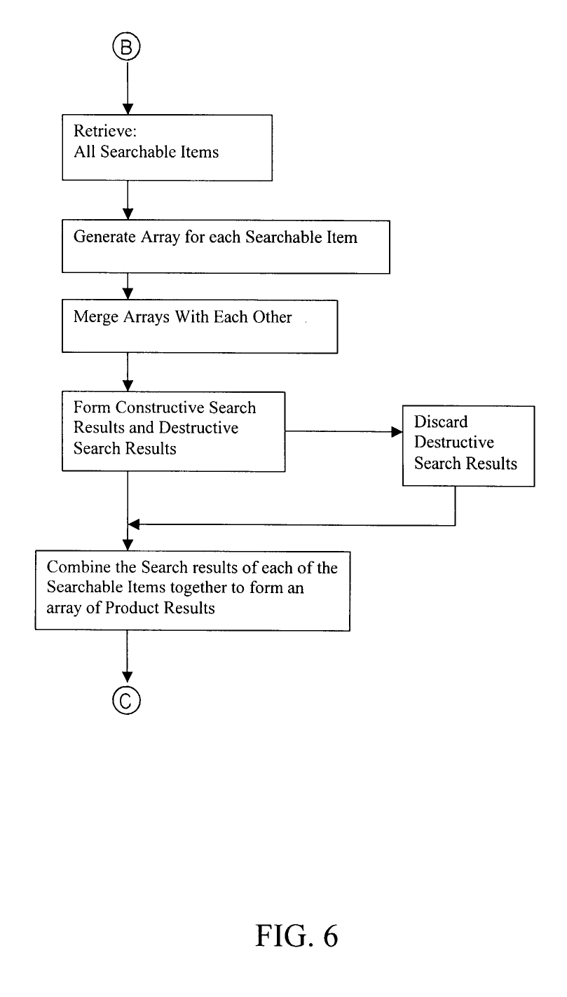

Accordingly, some search results of each searchable item may be discarded. As shown in FIG. 6, the search results of each searchable item are discarded with respect to the sorting criteria selected by the user in the step (2). If the search results are too large, an alternative of the process is to have the information center discard some useless search results to speed up the process of comparison.

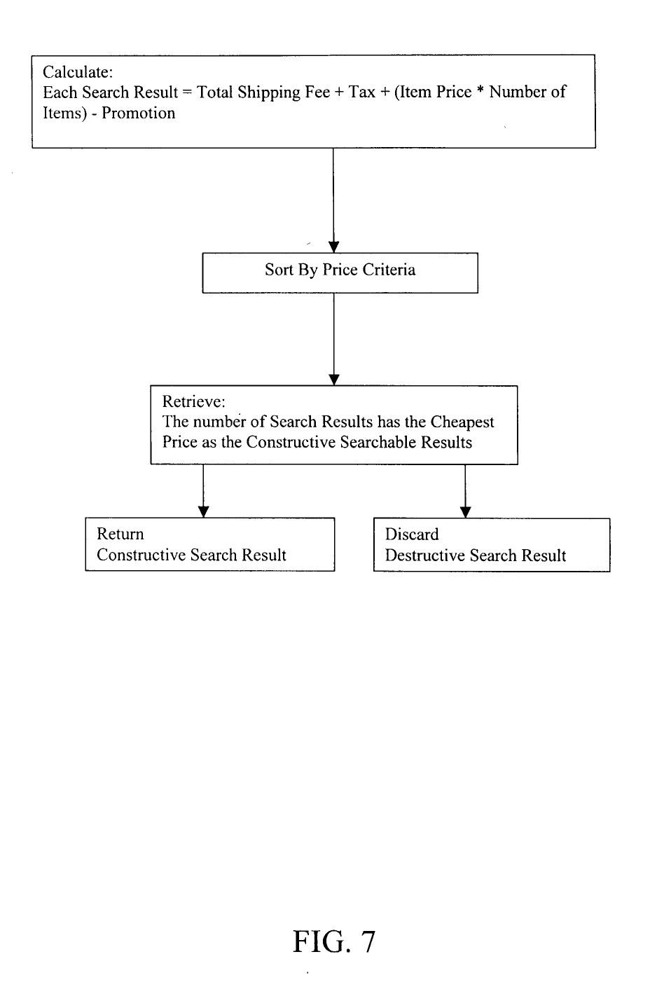

FIG. 7 illustrates the method for discarding the search results according to the price criteria. The total price of each search result of the searchable item is pre-calculated by the following formula.

Total price=Shipping fee+Tax+(item price*number of item)−Promotion.

For example, the supplier A carries the Book “A” having the price of $10 with no sales tax, wherein the supplier A offer a $2 shipping fee for each book and $5 off for purchasing two or more books. Therefore, when the user wants to purchase two of Book “A,” the cost will be calculated as follow: $4 of shipping fee+0 tax+($10*2)−$5 promotion=$19. After calculating all the cost of the search results, the search results of each search item are sorted out according to the total price starting with the lowest price.

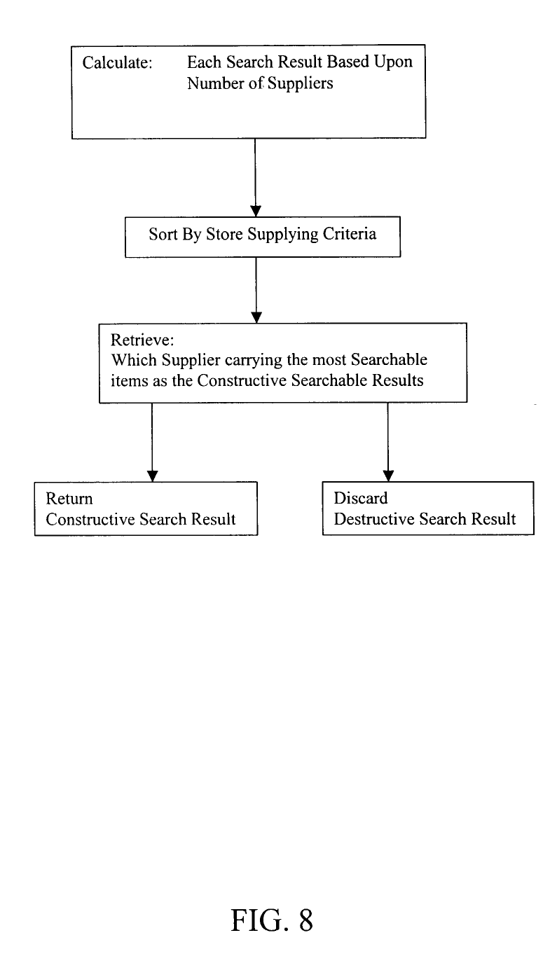

FIG. 8 illustrates the method of discarding the search results according to the store supplying criteria. The information center will compare all the possible suppliers from the search results in order to find out which supplier carries the most searchable items. For example, the supplier A carrying all the searchable items will be listed first and then the supplier carrying two out of three searchable items will be listed second, and so on.

A number of search results of each searchable item is pre-set as the constructive search results by the information center. For example, when the information center pre-sets only ten top listed search results for each searchable item as the constructive search results, the rest of the search results will be discarded. In other words, each searchable item containing ten search results will be stored in the user profile.

After selecting the desired searchable items in the user profile by the user, the searchable items will be combined for comparison. In step (4), the arrays of the corresponding searchable items are combined with each other to form the array of the product results. Accordingly, the arrays of the searchable items are mapped with each other by summing the price of each constructive search result of one array to the price of each constructive search result of another array.

For example, there are two searchable items, naming A and B, is selected in the user profile wherein the searchable item A has the array of constructive search results, A1 and A2, and the searchable item B has the array of constructive search results, B1, B2, B3. Therefore, when the two searchable items A and B are mapped together, the array of product results are formed as A1-B1, A1-B2, A1-B3, A2-B1, A2-B2, and A2-B3.

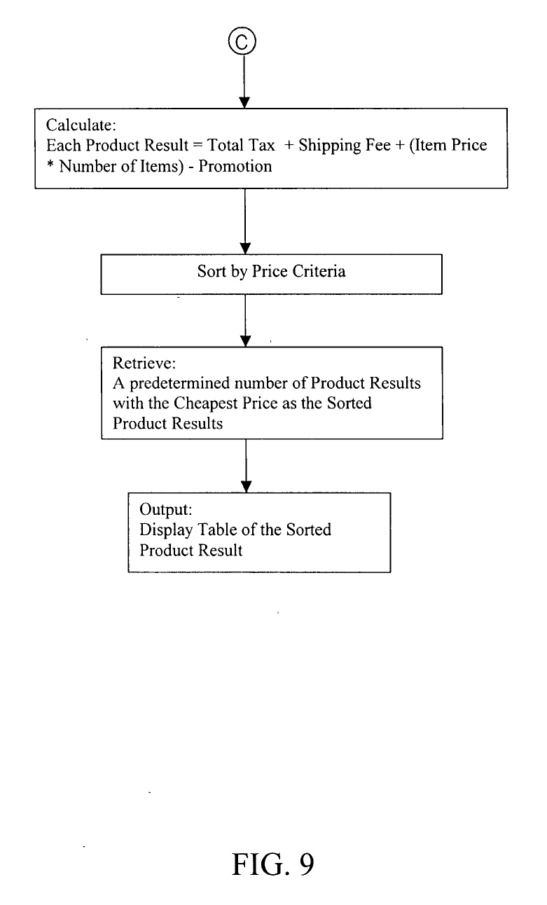

Each product result comprises all necessary information such as price information and contact information of the supplier or the suppliers with respect to the combined searchable items. As shown in FIG. 9, the total price of the searchable items may be calculated by the following formula.

Total price=Total Tax+Shipping fee+(Item price*number of item)−promotion.

For example, if three searchable items are selected to be compared, the information center provides the array of product results by calculating the total price of the three searchable items from one single supplier, the total price of three searchable items from two different suppliers, and the total price of the three searchable items from three different suppliers. By comparing the total prices of the product results, the lowest total price is adapted to be determined easily.

In step (5), the product results are sorted out orderly according to the sorting criteria selected by the user. It is worth mentioning that the promotion is one of the main factors for determining the total price of each product result since some suppliers may offer a special promotion for reducing the total price when the total price exceeds a certain amount or the user purchase more than one searchable item or certain quantity of each searchable item. For example, supplier A may offer a promotion of free shipping for any second item purchase. Therefore, the information center will put the promotion into the account for determining the lowest total price of each product result.

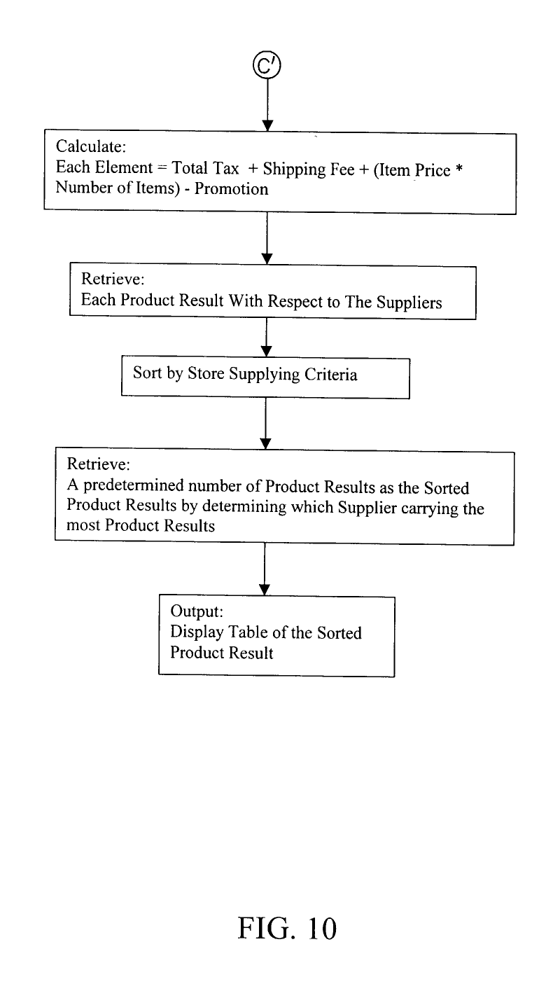

As shown in FIG. 10, the product results are sorted according to the store supplying criteria wherein the first product result is listed that all the searchable items are shipped from one single supplier. In other words, the user is able to get all the searchable items from one single supplier conveniently that may speed up the delivery time.

In step (6), the user is able to select one of the sorted product orders as a purchasing order. The user becomes a registered purchaser when the user sends the purchasing order to the information center through the electronic communication system, so that the registered purchase is adapted to communicate with the information center to directly purchase from the respective supplier through the information center.

Therefore, the information center is adapted to function as a conventional shopping site to send the purchasing order selected by the user to the respective suppliers, so as to save the user's time and speed up the deal between the user and the suppliers, especially when the user needs to purchase several products from different suppliers.

One skilled in the art will understand that the embodiment of the present invention as shown in the drawings and described above is exemplary only and not intended to be limiting.

It will thus be seen that the objects of the present invention have been fully and effectively accomplished. Embodiments have been shown and described for the purposes of illustrating the functional and structural principles of the present invention and is subject to change without departure from such principle. Therefore, this invention includes all modifications encompassed within the spirit and scope of the following claims.

What is claimed is:

1. A multiple-item searching method, comprising the steps of:
(a) providing an information center linked to a plurality of product databases of suppliers through an electronic communication system, each of said product database having price information and contact information for a set of products of said respective supplier;
(b) receiving a search request at said information center, by a user, including two or more searchable items and at least a sorting criteria;
(c) searching said product databases of said suppliers for said searchable items to generate at least a search result for each of said searchable items that matches one of said products in said product databases;
(d) combining said search results of each of said searchable items together to form an array of product results;
(e) sorting out said array of product results according to said sorting criteria to form an array of sorted product results; and
(f) providing said sorted product results for said user.

2. The method, as recited in claim 1, wherein said sorting criteria is a price criteria and said search results are sorted by calculating total prices of said search results respectively in an ascending order.

3. The method, as recited in claim 1, wherein said sorting order is a store supplying criteria and said search results are sorted by determining which supplier carrying most of said searchable items in a descending order.

4. The method, as recited in claim 1, wherein the step (d) further comprises the steps of:
(d.1) dividing said search results of each searchable item into a predetermined number of constructive search results and a predetermined number of destructive search results; and
(d.2) saving said constructive search results in said information center and discarding said destructive search results.

5. The method, as recited in claim 2, wherein the step (d) further comprises the steps of:
(d.1) dividing said search results of each searchable item into a predetermined number of constructive search results and a predetermined number of destructive search results; and
(d.2) saving said constructive search results in said information center and discarding said destructive search results.

6. The method, as recited in claim 3, wherein the step (d) further comprises the steps of:
(d.1) dividing said search results of each searchable item into a predetermined number of constructive search results and a predetermined number of destructive search results; and
(d.2) saving said constructive search results in said information center and discarding said destructive search results.

7. The method, as recited in claim 4, wherein the step (d), said constructive search results of searchable items are mapped together by summing a price of each constructive search result of said searchable item with a price of each constructive search result of another said searchable item.

8. The method, as recited in claim 5, wherein the step (d), said constructive search results of searchable items are mapped together by summing a price of each constructive search result of said searchable item with a price of each constructive search result of another said searchable item.

9. The method, as recited in claim 6, wherein in the step (d), said constructive search results of searchable items are mapped together by summing a price of each constructive search result of said searchable item with a price of each constructive search result of another said searchable item.

10. The method, as recited in claim 4, wherein in the step (d.1), said constructive search results are formed by sorting said search results of each said searchable item according to said sorting criteria and keeping said predetermined number of said search results of each searchable item as said constructive search results while the rest of said search results are formed as destructive search results.

11. The method, as recited in claim 8, wherein in the step (d.1), said constructive search results are formed by sorting said search results of each said searchable item according to said sorting criteria and keeping said predetermined number of said search results of each searchable item as said constructive search results while the rest of said search results are formed as destructive search results.

12. The method, as recited in claim 9, wherein in the step (d.1), said constructive search results are formed by sorting said search results of each said searchable item according to said sorting criteria and keeping said predetermined number of said search results of each searchable item as said constructive search results while the rest of said search results are formed as destructive search results

13. The method, as recited in claim 2, wherein the step (c) further comprises the steps of:
(c.1) collecting at least one of said search results of each of said searchable items into a user profile; and
(c.2) updating said searchable items in said user profile in order to combine said corresponding search results together.

14. The method, as recited in claim 3, wherein the step (c) further comprises the steps of:
(c.1) collecting at least one of said search results of each of said searchable items into a user profile; and
(c.2) updating said searchable items in said user profile in order to combine said corresponding search results together.

15. The method, as recited in claim 11, wherein the step (c) further comprises the steps of:
(c.1) collecting at least one of said search results of each of said searchable items into a user profile; and
(c.2) updating said searchable items in said user profile in order to combine said corresponding search results together.

16. The method, as recited in claim 12, wherein the step (c) further comprises the steps of:
(c.1) collecting at least one of each search results of each of said searchable items into a user profile; and
(c.2) updating said searchable items in said user profile in order to combine said corresponding search results together.

17. The method, as recited in claim 2, wherein, in the step (f), said user becomes a registered purchaser when said user selects one of said sorted product results as a purchase order and sends said purchasing order to said information center through said electronic communication system, so that said registered purchase is adapted to communicate with said information center to directly purchase from said respective supplier through said information center.

18. The method, as recited in claim 3, wherein, in the step (f), said user becomes a registered purchaser when said user selects one of said sorted product results as a purchase order and sends said purchasing order to said information center through said electronic communication system, so that said registered purchase is adapted to communicate with said information center to directly purchase from said respective supplier through said information center.

19. The method, as recited in claim 11, wherein, in the step (f), said user becomes a registered purchaser when said user selects one of said sorted product results as a purchase order and sends said purchasing order to said information center through said electronic communication system, so that said registered purchase is adapted to communicate with said information center to directly purchase from said respective supplier through said information center.

20. The method, as recited in claim 12, wherein, in the step (f), said user becomes a registered purchaser when said user selects one of said sorted product results as a purchase order and sends said purchasing order to said information center through said electronic communication system, so that said registered purchase is adapted to communicate with said information center to directly purchase from said respective supplier through said information center.
